(19) United States
(12) Patent Application Publication
(10) Pub. No.: US 2023/0382251 A1
(43) Pub. Date: Nov. 30, 2023

(54) Electric Vehicle Charging Station

(71) Applicant: Dunamis Charge, Inc., Southfield, MI (US)

(72) Inventor: David Ellis, Southfield, MI (US)

(21) Appl. No.: 18/196,464

(22) Filed: May 12, 2023

Related U.S. Application Data
(60) Provisional application No. 63/365,526, filed on May 31, 2022.

(51) Int. Cl. B60L 53/30; B60L 53/16; B60L 53/34

(52) U.S. Cl. CPC B60L 53/305; B60L 53/16; B60L 53/34; B60L 2210/30; B60L 2250/16

(57) ABSTRACT

An electric vehicle charging station includes a bracket, a case mounted to the bracket, a motherboard disposed within the case, a cover disposed on the case, a display screen disposed on the cover, and a conduit disposed on the case. The motherboard for the electric vehicle charging station includes a circuit breaker, a rectifier circuit, a power control unit, a charge controller, and a variable DC power supply.

### CROSS REFERENCE TO RELATED APPLICATIONS

This application claims priority to provisional application App. No. 63/365,526 filed May 31, 2022 the contents are incorporated by references herein.

### BACKGROUND

Infrastructure changes are necessary to support widespread adoption of electric vehicles. For example, parking lots, parking garages, rest stops, and even homes must be updated to facilitate electric vehicle charging before electric vehicles can overtake gasoline-powered vehicles among consumers.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

One or more aspects of the present disclosure pertains to an electric vehicle charging station, including a bracket for mounting the electric vehicle charging station to a support structure; a case mounted to the bracket; a motherboard disposed within the case, including a sensing and detection block electrically coupled to a charge controller processor with computer readable memory for receiving computer readable data from an electric vehicle, and a control unit processor; a cover removably coupled and disposed on the case; a touch-sensitive display screen electrically connected to a control unit processor and the display screen being disposed on the cover; and a conduit for receiving AC electrical power disposed on the case.

One or more aspects of the present disclosure pertains to an electric vehicle charging station including a bracket; a case mounted to the bracket; a motherboard disposed within the case; a cover disposed on the case; a display screen disposed on the cover; and a conduit disposed on the case.

One or more aspects of the present disclosure pertains to an electric vehicle charging station in which the case and the bracket define openings, and wherein the cover includes protrusions configured to be inserted into the openings when the cover is in an open position.

One or more aspects of the present disclosure pertains to an electric vehicle charging station comprising a support disposed on a back surface of the cover for securing the display screen to the back surface of the cover.

One or more aspects of the present disclosure pertains to a motherboard for an electric vehicle charging station including a circuit breaker; a rectifier circuit; a power control unit; a charge controller; and a variable DC power supply.

One or more aspects of the present disclosure pertains to a motherboard for an electric vehicle charging station including a power stage block; a sensing and detection block; and a control unit.

One or more aspects of the present disclosure pertains to a motherboard for an electric vehicle charging station wherein the power stage block includes: a terminal block; a sensing and ground-fault circuit interrupter block; a first relay; a second relay; a first connector interface; and a second connector interface.

One or more aspects of the present disclosure pertains to a motherboard for an electric vehicle charging station wherein the sensing and detection block includes: an AC-DC converter block; an input voltage signal filtering block; an input current signal filtering block; a GFCI detection block; a relay driver; and a pilot signal generation block.

One or more aspects of the present disclosure pertains to a motherboard for an electric vehicle charging station wherein the motherboard further includes a peripherals block.

One or more aspects of the present disclosure pertains to a motherboard for an electric vehicle charging station wherein the peripherals block includes: a short-range communication block; a display block; and a long-range communication block.

### BRIEF DESCRIPTION OF THE DRAWINGS

FIG. 1 illustrates an exploded view of an example electric vehicle charging station according to the teachings of the present disclosure.

FIG. 2 is a block diagram showing example components of the electric vehicle charging station interfacing with an electric vehicle according to the teachings of the present disclosure.

FIG. 3 is a block diagram showing example components of a motherboard used with the electric vehicle charging station according to the teachings of the present disclosure.

FIGS. 4A-4G is a schematic diagram showing example components of the motherboard used with the electric vehicle charging station according to the teachings of the present disclosure.

FIGS. 5A-5B are perspective views of the electric vehicle charging station with a front cover open according to the teachings of the present disclosure.

FIG. 6 illustrates an exploded view of a back surface of the front cover with a display screen mounted thereon according to the teachings of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

Major infrastructure changes are easier said than done. The vast majority of public and private buildings, roads, parking lots, rest stops, etc., were not designed to accommodate electric vehicle charging stations. Installing electric vehicle charging stations in existing buildings and structures proves challenging.

One way to simplify installation is with an electric vehicle charging station that includes a bracket, a case mounted to the bracket, a motherboard disposed within the case, a cover disposed on the case, a display screen disposed on the cover, and a conduit disposed on the case. The cover may be held in place during installation and/or maintenance by openings defined by the bracket and the case.

Further, the electric vehicle charging station may have a small form factor facilitated by the motherboard. In this example implementation, the motherboard for the electric vehicle charging station includes a circuit breaker, a rectifier circuit, a power control unit, a charge controller, and a variable DC power supply.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

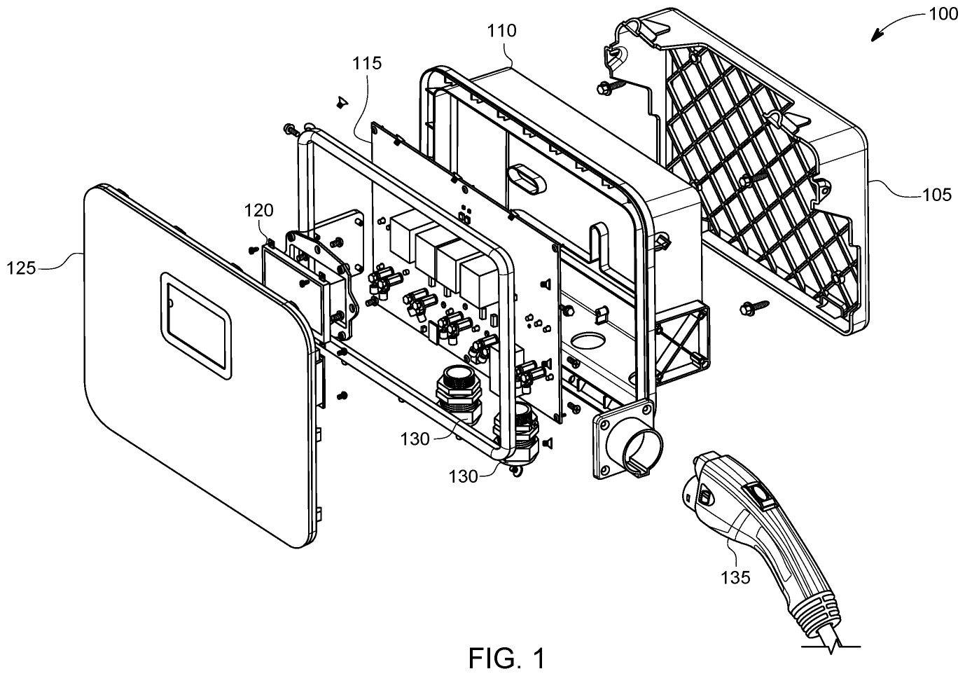

As illustrated in FIG. 1, the electric vehicle charging station 100 includes a bracket 105, a case 110, a motherboard 115, a display screen 120, a cover 125, conduits 130, and a charger 135. The electric vehicle charging station 100 can be mounted to the wall of a building. In some instances, the electric vehicle charging station 100 can be mounted to a post.

The bracket 105 allows the electric vehicle charging station 100 to attach to a wall or post at an installation location. The bracket 105 may be formed from plastic, metal, or another rigid material capable of supporting the weight of the other components of the electric vehicle charging station 100. The bracket 105 defines holes 295 for receiving fasteners, such as screws. The bracket 105 may be placed onto a wall or post, and the fasteners may be inserted into the holes 295 to fasten the bracket 105 to the wall or post.

The case 110 attaches to the bracket 105 and holds various components of the electric vehicle charging station 100 such as the motherboard 115, display screen 120, cover 125, conduits 130, and charger 135. The case 110 may be formed from plastic, metal, or another rigid material capable of housing certain other components of the electric vehicle charging station 100, such as the motherboard 115, and supporting the weight of that and possibly other components of the electric vehicle charging station 100, such as the display screen 120, cover 125, conduits 130, and charger 135.

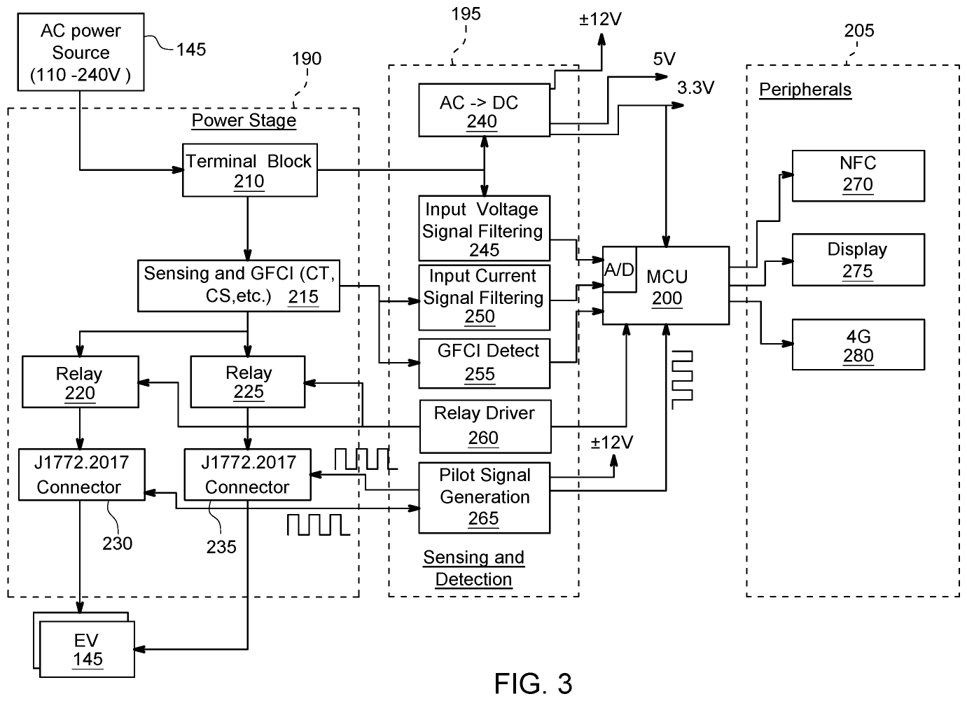

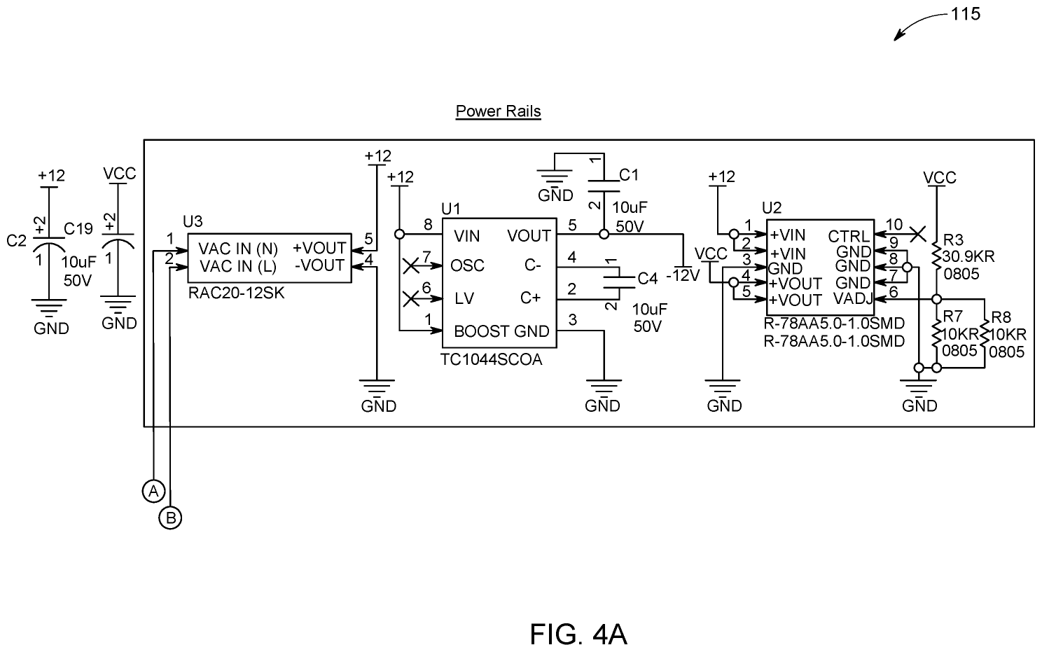

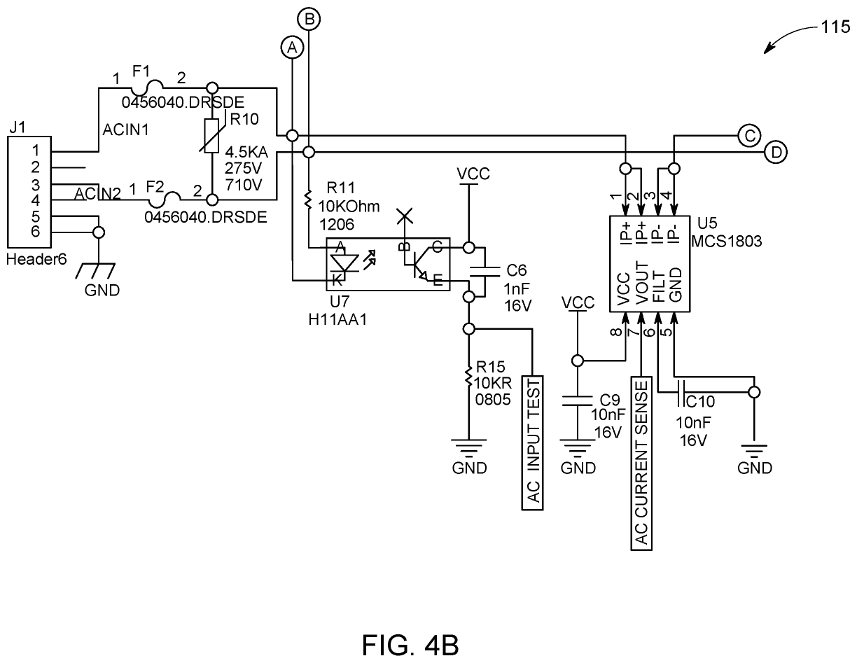

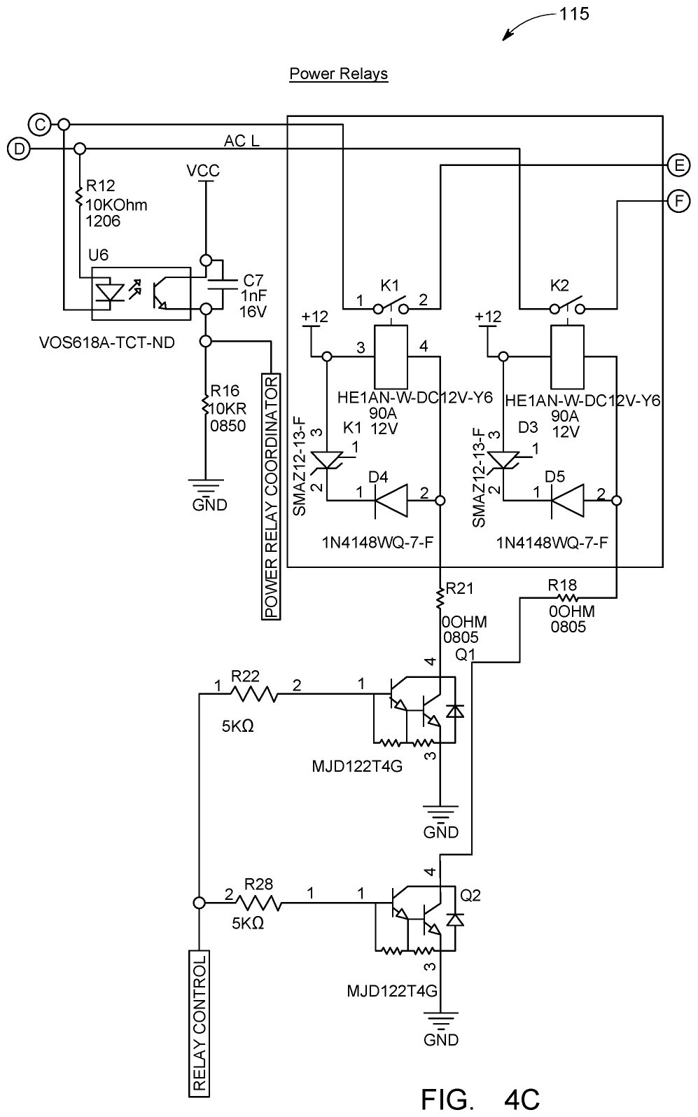

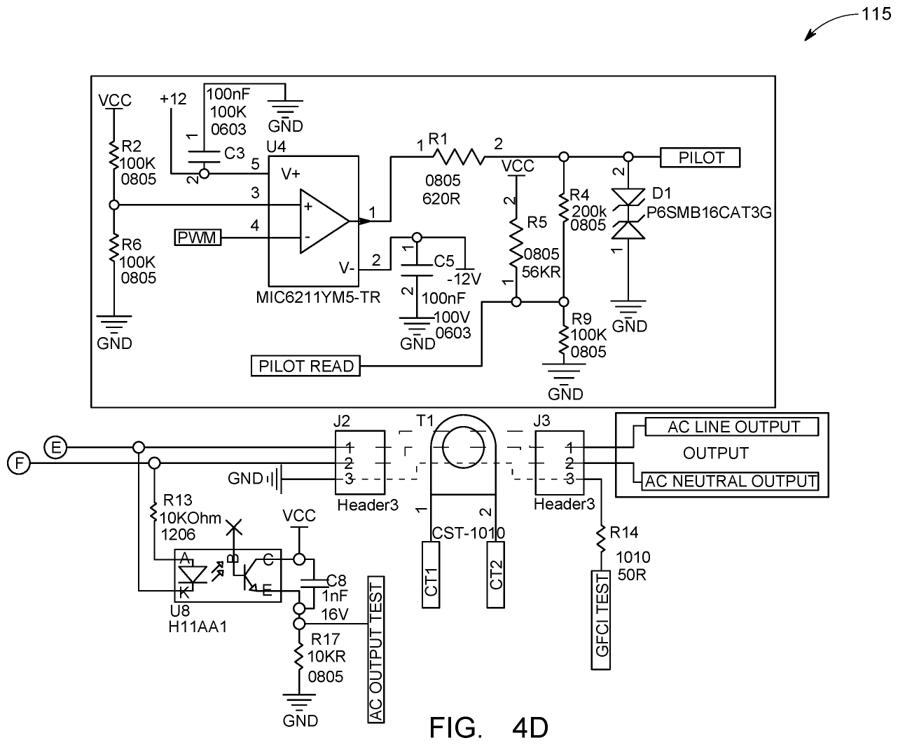

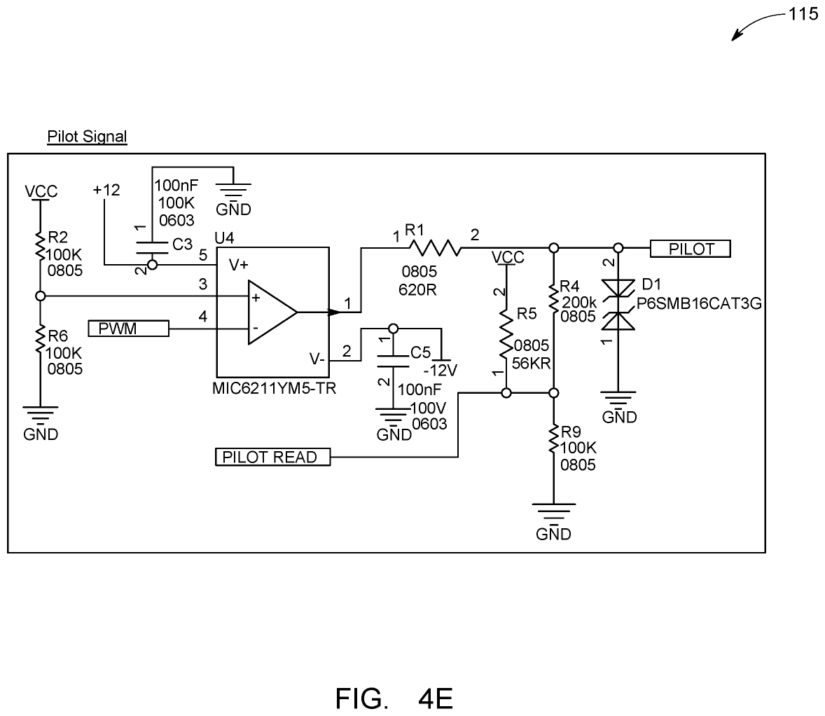

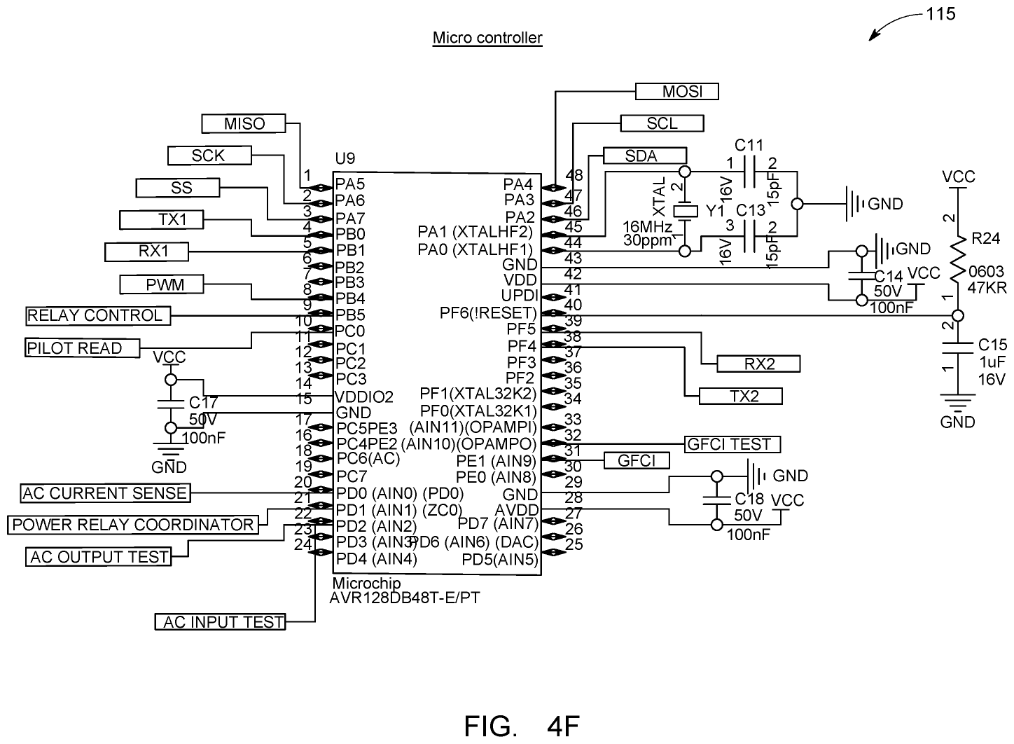

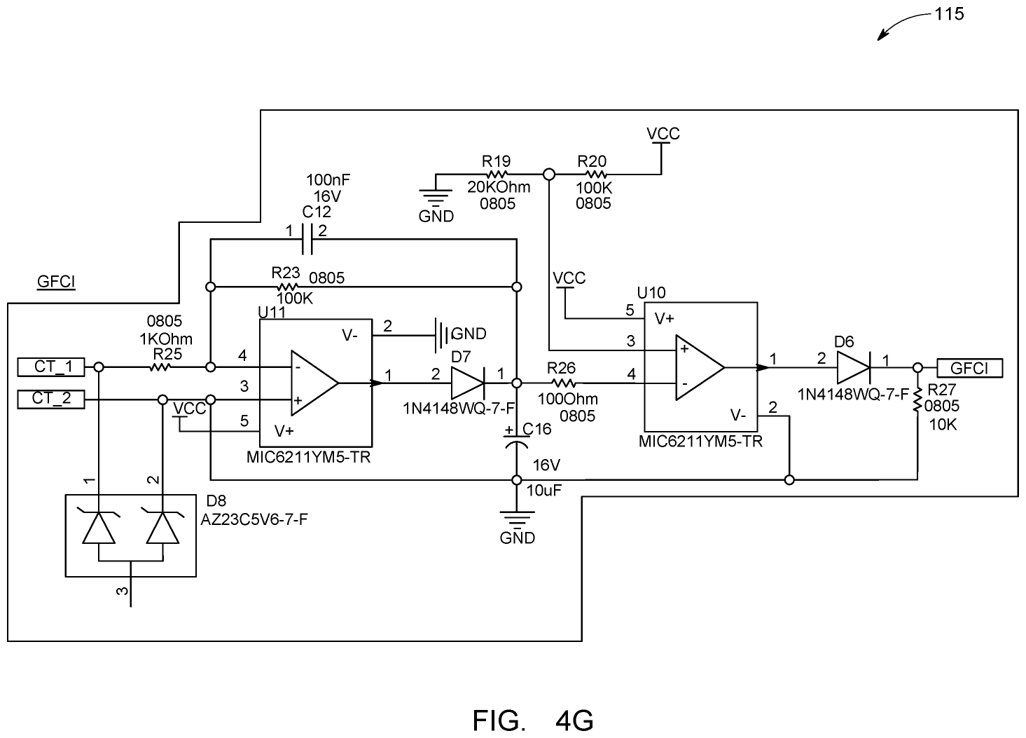

The motherboard 115 is a printed circuit board with electronic components that facilitate operation of the electric vehicle charging station 100. The electronic components may be soldered onto the printed circuit board and connected via traces on the printed circuit board. Specific components of the motherboard 115 are discussed in greater detail below with respect to FIGS. 3 and 4. At a high level, the motherboard 115 causes the electric vehicle charging station 100 to receive alternating current (AC) electrical energy, convert the AC electrical energy into direct current (DC) electrical energy, and provide the DC electrical energy to an electric vehicle via the charger 135.

The display screen 120 is an electronic device configured to present information to a user of the electric vehicle charging station 100. The display screen 120 may include electronics and a screen such as a liquid crystal display (LCD) screen. In some possible approaches, the display screen 120 is a touch-sensitive screen configured to receive inputs as well as present information to a user. The display screen 120 may be operatively connected to the motherboard 115. In that instance, the motherboard 115 may control the operation of the display screen 120. In other implementations, the display screen 120 may include a controller or processor separate from any electronic devices disposed on the motherboard 115.

The cover 125 protects certain components of the electric vehicle charging station 100. For instance, the cover 125 may protect the display screen 120 and motherboard 115 from the elements such as rain or snow. In other instances, the cover 125 reduces the risk of damage to the display screen 120 and components of the motherboard 115. In some implementations, the cover 125 is aesthetic. The cover 125 may be formed from plastic, metal, or another material.

The conduits 130 serve as an interface between electrical mains and the charger 135. For instance, the conduits 130 may allow one or more components of the motherboard 115 to receive power from an AC power supply 140. The electric vehicle charging station 100 may include any number of conduits 130. For instance, one conduit 130 may serve as a positive terminal and another conduit 130 may serve as a negative or ground terminal.

The charger 135 serves as an interface between the electric vehicle charging station 100 and an electric vehicle. That is, the charger 135 may be configured to plug into the electric vehicle and transfer electrical energy from the electric vehicle charging station 100 to, e.g., a battery 175 of the electric vehicle. The charger 135 may have a custom or proprietary shape and configuration to fit a particular electric vehicle. Alternatively, the shape and configuration of the charger 135 may comply with a standard. For instance, the charger 135 may be a J1772.2017 connector.

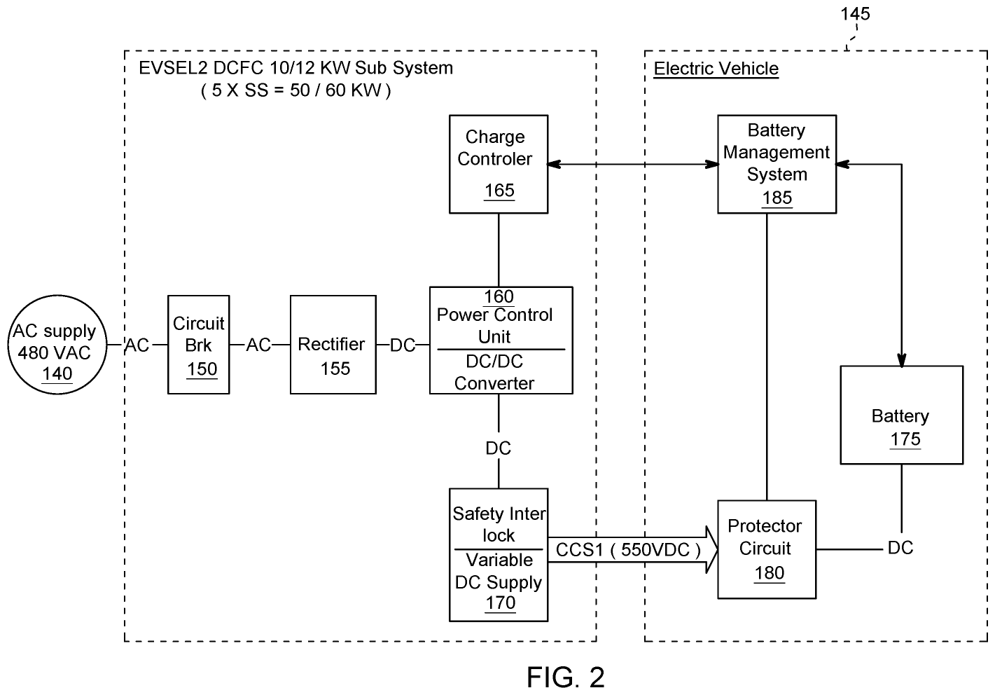

FIG. 2 is a block diagram showing how components of the electric vehicle charging station 100 interface with an AC power supply 140 and an electric vehicle 145. As shown, the electric vehicle charging station 100 includes a circuit breaker 150, a rectifier circuit 155, a power control unit 160, a charge controller 165, and a variable DC power supply 170. The electric vehicle 145, as shown, includes a battery 175, a protector circuit 180, and a battery management system 185.

The AC power supply 140 refers to a line voltage or electrical main provided to the electric vehicle charging station 100. The AC power supply 140 may provide, e.g., 120 volts, 240 volts, 480 volts of alternating current to the electric vehicle charging station 100.

The circuit breaker 150 may be configured to receive the line voltage from the AC power supply 140. The circuit breaker 150 may include electronic components that protect the electric vehicle charging station 100 from voltage spikes, a short circuit, or other abnormally high voltages or currents that could damage components of the electric vehicle charging station 100. Upon receipt of a potentially damaging high voltage or current, a relay of the circuit breaker 150 may open to disconnect the potentially damaging high voltage or current from the remainder of the electric vehicle charging station 100.

The rectifier circuit 155 converts the AC voltage from the AC power supply 140 into a direct current (DC) signal. The rectifier circuit 155 may include various electronic components including one or more transformers, diodes, and/or resistors. The output of the rectifier circuit 155 may be a DC signal to the power control unit 160. The DC signal may be a function of the peak voltage and/or the root mean squared (RMS) voltage of the AC voltage received from the AC power supply 140.

The power control unit 160 may include a DC-DC converter that converts the output of the rectifier circuit 155 to a lower DC voltage appropriate for charging the electric vehicle 145. For instance, the power control unit 160 may reduce the DC signal output by the rectifier circuit 155 to a DC voltage associated with a maximum output current of 20-80 amps.

The charge controller 165 may be configured to exchange electronic communications with the electric vehicle 145. For instance, the charge controller 165 may include electronic components that receive and process signals transmitted from the electric vehicle 145. The charge controller 165 may coordinate the starting and stopping of the charging procedure with the electric vehicle 145. That is, the charge controller 165 may receive, from the electric vehicle 145, a value representing the capacity or health of the battery 175. With such information, the charge controller 165 may determine that the battery 175 is ready for charging and output a signal to the power control unit 160 to begin charging the battery 175. Moreover, the charge controller 165 may receive a signal indicating that the battery 175 has been sufficiently charged. In that instance, the charge controller 165 may direct the power control unit 160 to stop charging the battery 175.

The variable DC power supply 170 outputs a DC signal to the electric vehicle 145. The DC signal may be the DC signal output by the DC-DC converter of the power control unit 160. In some instances, the variable DC power supply 170 includes a safety interlock. The safety interlock may include components that detect that the charger 135 is plugged into a charge port of the electric vehicle 145. The variable DC power supply 170 may be configured or programmed to output the DC signal to the electric vehicle 145 if the charger 135 is plugged into the charge port. In some instances, the safety interlock includes a switch that is closed when the charger 135 is plugged into the charge port. When the charger 135 is removed from the charge port, the switch opens to prevent the variable DC power supply 170 from outputting the DC signal.

The battery 175 stores and provides electrical energy that can be used to power the electric vehicle 145. The battery 175 may include a number of electrochemical cells that store electricity. The battery 175 may include terminals connected to one or more electrical components of the electric vehicle 145. DC energy may flow from the battery 175 to one or more electrical components of the electric vehicle 145 through the terminals. The battery 175 may also be charged through the terminals. That is, the DC signal output by the variable DC power supply 170 may be provided to the battery 175 through the terminals.

The protector circuit 180 may be electrically connected between the electric vehicle charging station 100 and the battery 175. Specifically, the protector circuit 180 may be electrically connected between the variable DC power supply 170 and the battery 175. The protector circuit 180 may include electronic components that protect the battery 175 from potentially damaging signals output by the variable DC power supply 170. For instance, the protector circuit 180 may include one or more switches that open in response to detecting a voltage or current that could damage the battery 175.

The battery management system 185 includes one or more electronic components that can evaluate the battery 175 charge and other state of health metrics and communicate such information to the electric vehicle charging station 100. For instance, the battery management system 185 may be configured to determine that the battery 175 is not yet fully charged and communicate such information to the charge controller 165 of the electric vehicle charging station 100. After some time, the battery management system 185 may be configured to check the state of charge again. Upon determining that the battery 175 is fully charged, the battery management system 185 may be configured to communicate to the charge controller 165 that the battery 175 is fully charged and that charging should cease.

FIG. 3 is a block diagram showing example components of a motherboard 115 used with the electric vehicle charging station 100. As shown, the motherboard 115 includes power stage blocks 190, sensing and detection blocks 195, a control unit 200, and peripherals 205.

At a high level, the power stage blocks 190 facilitate the transfer of electrical energy from the AC power supply 140 to the electric vehicle 145. The power stage blocks 190 shown in FIG. 3 include a terminal block 210, sensing and ground-fault circuit interrupter (GFCI) block 215, a first relay 220, a second relay 225, a first connector interface 230, and a second connector interface 235. The terminal block 210 receives the signal from the AC power supply 140 discussed above with respect to FIG. 2. The sensing and GFCI block 215 is operationally connected to the terminal block 210, the first relay 220, and the second relay 225. The first relay 220 and the second relay 225 transmit electrical energy to the first connector interface 230 and the second connector interface 235, respectively. The first connector interface 230 and second connector interface 235 may be J1772.2017 connectors.

The sensing and detection blocks 195 include an AC-DC converter block 240, an input voltage signal filtering block 245, an input current signal filtering block 250, a GFCI detection block 255, a relay driver 260, and a pilot signal generation block 265. The AC-DC converter block 240, which is electrically connected to the terminal block 210 and the input voltage signal filtering block 245, is configured to output one or more lower voltage signals, such as a 12V signal, a 5V signal, and/or a 3.3V signal. The input voltage signal filtering block 245 is electrically connected to the AC-DC converter block 240, the terminal block 210, and the control unit 200. The input current signal filtering block 250 and the GFCI detection block 255 are each electrically connected to the sensing and ground-fault circuit interrupter (GFCI) block and the control unit 200. The relay driver 260 is electrically connected to the control unit 200, the first relay 220, and the second relay 225. The pilot signal generation block 265 is electrically connected to the control unit 200, the first connector interface 230, and the second connector interface 235.

The control unit 200 may be a microprocessor-based controller implemented via circuits, chips, or other electronic components. For example, the controller may include a processor, non-transitory computer readable memory, etc. The non-transitory computer readable memory of the control unit 200 is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store instructions executable by the processor of the control unit 200. The processor of the control unit 200 is implemented via circuits, chips, or other electronic components and may include one or more microcontrollers, one or more field programmable gate arrays (FPGAs), one or more application specific integrated circuits (ASICs), one or more digital signal processors (DSPs), one or more customer specific integrated circuits, etc. The processor may access and execute the computer readable instructions stored in the memory to control the operation of the electric vehicle charging station 100.

The peripherals 205 may include drivers for external devices. For instance, the peripherals 205 may include a short-range communication block 270, a display block 275, and a long-range communication block 280. The short-range communication block 270 is electrically connected to the control unit 200 and implemented via an antenna, circuits, chips, or other electronic components that facilitate short-range wireless communication in accordance with a near-field communication (NFC), Bluetooth®, Bluetooth® Low Energy, WiFi, dedicated short-range communication (DSRC), or the like. The display block 275 is electrically connected to the control unit 200 and may include hardware and/or software for operating the display screen 120 shown in FIG. 1. The long-range communication block 280 is electrically connected to the control unit 200 and implemented via an antenna, circuits, chips, or other electronic components that facilitate long-range wireless communication in accordance with a satellite-communication protocol, a cellular-based communication protocol (5G, LTE, 3G, etc.), or the like.

FIGS. 4A-4G is a schematic diagram showing example components of the motherboard 115 used with the electric vehicle charging station 100. The components shown in the motherboard 115 of FIGS. 4A-4G may implement the structure and functionality of the blocks discussed above with respect to FIG. 3.

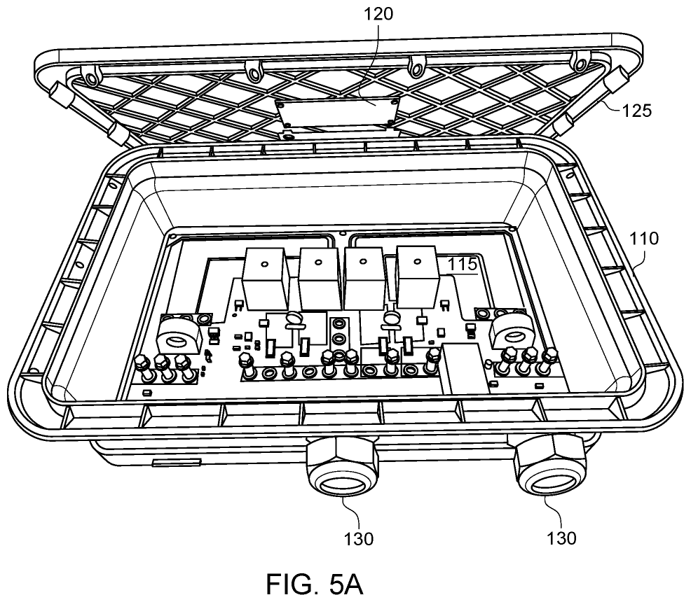

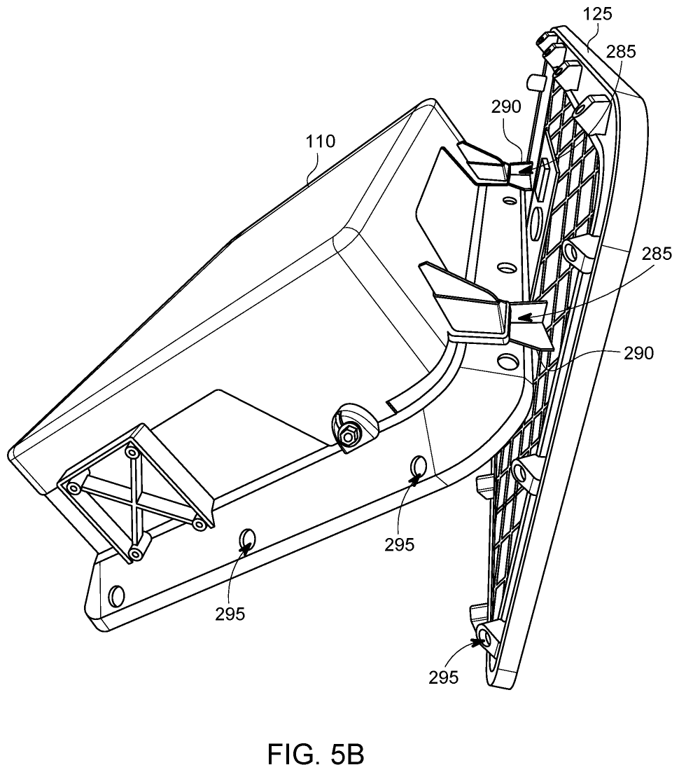

FIGS. 5A-5B are perspective views of the electric vehicle charging station 100 with the cover 125. This configuration of the electric vehicle charging station 100 allows for faster installation. For instance, the cover 125 can be unfastened from the case 110. As shown in FIG. 5B, openings 285 are defined between the case 110 and the bracket 105. The cover 125 includes protrusions 290 that can be inserted into the openings 285. When inserted into the openings 285, the cover 125 is held in place. An installer may insert the protrusions 290 into the openings 285 during the installation and/or maintenance of the electric vehicle charging station 100. That is, the cover 125 may be held in an open position (shown in FIGS. 5A and 5B) while the installer makes the appropriate electrical connections to install the electric vehicle charging station 100 to the AC power supply 140, the charger 135, or both. Moreover, the cover 125 may be held in the open position if the motherboard 115, or any parts thereof, or the display screen 120 need to be replaced or serviced. When installation or maintenance is complete, the installer may remove the cover 125 from the openings 285 and place the cover 125 against the case 110 such that holes 295 in the cover 125 and case 110 may align. The holes 295 of the cover 125 may be threaded to, e.g., receive screws or another fastener that can hold the cover 125 in place.

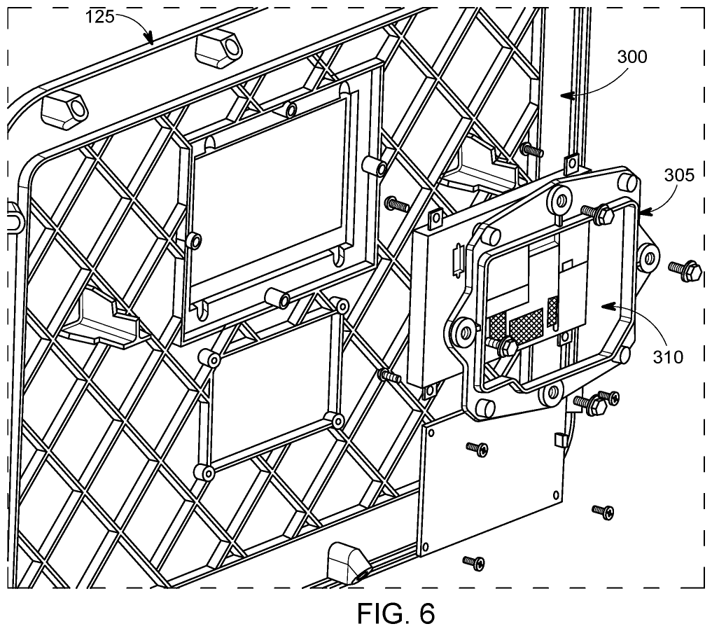

FIG. 6 illustrates an exploded view of a back surface 300 of the cover 125 with the display screen 120 mounted thereon. The cover 125 may define a window, and the display screen 120 may be mounted such that it aligns with the window of the cover 125. A support 305 may be placed behind the display screen 120 and fastened to the back surface of the cover 125. When fastened to the back surface of the cover 125, the support 305 may hold the display screen 120 in place. In some possible implementations, the support 305 defines a space 310 to allow wires to electrically connect the display screen 120 to the motherboard 115.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An electric vehicle charging station, comprising:
a bracket for mounting the electric vehicle charging station to a support structure;
a case mounted to the bracket;
a motherboard disposed within the case, including a sensing and detection block electrically coupled to a charge controller processor with computer readable memory for receiving computer readable data from an electric vehicle, and a control unit processor;
a cover removably coupled and disposed on the case;
a touch-sensitive display screen electrically connected to a control unit processor and the display screen being disposed on the cover; and
a conduit for receiving AC electrical power disposed on the case.

2. The electric vehicle charging station of claim 1, wherein the case and the bracket define openings, and wherein the cover includes protrusions configured to be inserted into the openings when the cover is in an open position.

3. The electric vehicle charging station of claim 1, further comprising a support disposed on a back surface of the cover for securing the display screen to the back surface of the cover.

4. The electric vehicle charging station of claim 1, wherein the sensing and detection block further comprises:
an AC-DC converter block electronically coupled to the conduit;
an input voltage signal filtering block logically coupled to the control unit processor;
an input current signal filtering block electronically coupled to the control unit processor;
a GFCI detection block electronically coupled to the control unit processor;
a relay driver electronically coupled to the control unit processor; and
a pilot signal generation block electronically coupled to the control unit processor.

5. The electric vehicle charging station of claim 4, wherein the motherboard further comprises a power stage block logically coupled to the control unit processor.

6. The electric vehicle charging station of claim 5, wherein the power stage block further comprises:
a terminal block;
a sensing and ground-fault circuit interrupter block;
a first relay;
a second relay;
a first connector interface; and
a second connector interface.

10. The electric vehicle charging station of claim 5, wherein the motherboard further includes a peripherals block logically coupled to the control unit processor.

11. The electric vehicle charging station of claim 10, wherein the peripherals block further comprises:
a short-range communication block logically coupled to the control unit processor;
a display block logically coupled to the control unit processor for controlling the touch-sensitive display screen; and
a long-range communication block logically coupled to the control unit processor.

12. A motherboard for an electric vehicle charging station comprising:
a circuit breaker;
a rectifier circuit;
a power control unit;
a charge controller processor for receiving computer readable data from an electric vehicle; and
a variable DC power supply.

13. A motherboard for an electric vehicle charging station comprising:
a power stage block;
a sensing and detection block; and
a control unit.

14. The motherboard of claim 13, wherein the power stage block includes:
a terminal block;
a sensing and ground-fault circuit interrupter block;
a first relay;
a second relay;
a first connector interface; and
a second connector interface.

15. The motherboard of claim 14, wherein the sensing and detection block includes:
an AC-DC converter block;
an input voltage signal filtering block;
an input current signal filtering block;
a GFCI detection block;
a relay driver; and
a pilot signal generation block.

16. The motherboard of claim 15, wherein the motherboard further includes a peripherals block.

17. The motherboard of claim 16, wherein the peripherals block includes:
a short-range communication block;
a display block; and
a long-range communication block.
